(19) United States
(12) Patent Application Publication
(10) Pub. No.: US 2023/0206689 A1
(43) Pub. Date: Jun. 29, 2023

(54) METHODS AND APPARATUS TO MEASURE FACIAL ATTENTION

(71) Applicant: The Nielsen Company (US), LLC, New York, NY (US)

(72) Inventors: Padmanabhan Soundararajan, Tampa, FL (US); Alan Lekah, Delray Beach, FL (US); Meryem Berrada, Beacon, NY (US)

(21) Appl. No.: 17/969,530

(22) Filed: Oct. 19, 2022

Related U.S. Application Data
(60) Provisional application No. 63/294,809, filed on Dec. 29, 2021.

(51) Int. Cl. G06V 40/16; G06T 7/62

(52) U.S. Cl. CPC G06V 40/174; G06T 7/62; G06V 40/171; G06T 2207/30201

(57) ABSTRACT

Methods, apparatus, systems, and articles of manufacture to measure facial attention are disclosed. An example apparatus includes at least one memory, machine readable instructions, and processor circuitry to at least one of instantiate or execute the machine readable instructions to identify facial landmarks from input image data, the facial landmarks corresponding to coordinates of landmarks of a face detected in the input image data, determine a first distance between a first facial landmark of the facial landmarks and a second facial landmark of the facial landmarks, determine a second distance between the first facial landmark and a third facial landmark of the facial landmarks, and compare a quotient of the first distance and the second distance to a threshold to determine an attentiveness metric.

### FIELD OF THE DISCLOSURE

This disclosure relates generally to audience measurement and, more particularly, to methods and apparatus to measure facial attention.

### BACKGROUND

Audience measurement entities (AMEs), such as The Nielsen Company (US), LLC, may extrapolate audience viewership data for a media viewing audience. AMEs may collect audience viewership data via monitoring devices that gather media exposure data that measures exposure to media in an environment and/or other market research data.

### BRIEF DESCRIPTION OF THE DRAWINGS

FIG. 1 is a block diagram of an example attention measuring circuitry to measure attention of an audience member of media.

FIG. 2 is a block diagram of example facial attention determination circuitry included in the example of FIG. 1 to measure facial attention in accordance with teaching of this disclosure.

FIGS. 3A and 3B are illustrations of example facial landmarks.

FIGS. 4-7 depict flowcharts representative of example machine readable instructions and/or example operations that may be executed by example processor circuitry to implement the facial attention determination circuitry of FIGS. 1 and 2.

FIG. 8 is a block diagram of an example processing platform including processor circuitry structured to execute the example machine readable instructions and/or the example operations of FIGS. 4-7 to implement the facial attention determination circuitry of FIGS. 1 and 2.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 4-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +/- 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Media monitoring entities, such as The Nielsen Company (US), LLC, desire knowledge regarding how users interact with media devices, such as smartphones, tablets, laptops, smart televisions, etc. For example, media monitoring entities monitor media presentations made at the media devices to, among other things, monitor exposure to advertisements, determine advertisement effectiveness, determine user behavior, identify purchasing behavior associated with various demographics, etc. Media monitoring entities can provide media meters to people (e.g., panelists) which can generate media monitoring data based on the media exposure of those users. Such media meters can be associated with a specific media device (e.g., a television, a mobile phone, a computer, etc.) and/or a specific person (e.g., a portable meter, etc.).

Various monitoring techniques for monitoring user interactions with media are suitable. For example, television viewing or radio listening habits, including exposure to commercials therein, are monitored utilizing a variety of techniques. In some example techniques, acoustic energy to which an individual is exposed is monitored to produce data which identifies or characterizes a program, song, station, channel, commercial, etc., that is being watched or listened to by the individual. In some example techniques, a signature is extracted from transduced media data for identification by matching with reference signatures of known media data.

In the past, media audience measurements focused on measuring the exposure of a person to media content (e.g., a TV show, an advertisement, a song, etc.). As used herein, the term “media content” includes any type of content and/or advertisement delivered via any type of distribution medium. Thus, media includes television programming or advertisements, radio programming or advertisements, movies, web sites, streaming media, etc. More recently, media monitoring entities are interested in measuring the attentiveness of a person to the media content. In examples disclosed herein, an attentiveness metric is representative of the effectiveness of the media being played, which can augment measurement of whether the person was present/exposed to the media. For example, the attentiveness metric may be a score representative of a probability or likelihood that a measured media exposure was effective in capturing the attention of a person). However, measuring the attentiveness, engagement, and/or reaction of a person to media content can be more challenging than determining exposure.

Examples disclosed herein provide a method to measure attention using facial landmarks to determine if a person’s face is turned towards the media device or away from the media device. Examples disclosed herein determine if a person’s face is turned towards or away from the media device to measure user attentiveness (e.g., an attentiveness metric). Examples disclosed herein use a neural network to determine five facial landmarks from input image data representative of an environment including the media device (e.g., TV, laptop, etc.). In some examples, the examples disclosed herein use an example Multi-task Cascade CNN (MTCNN) facial detector to determine the five facial landmarks. In examples disclosed herein, the five facial landmarks include the left eye, the right eye, the nose, the left mouth, and the right mouth. However, examples disclosed herein can additionally and/or alternatively use any other appropriate facial landmarks for determining attentiveness.

Examples disclosed herein compute distances of the nose landmark point relative to the top/bottom landmarks (e.g., the left eye and the right eye, the left mouth and the right mouth, etc.) to estimate vertical attentiveness of a person. Examples disclosed herein also estimate the horizontal attentiveness by computing distances of the nose landmark point relative to the and left/right landmarks (e.g., the left eye and left mouth, the right eye and the right mouth, etc.). Examples disclosed herein determine an attentiveness metric of the face by computing how much the nose landmark deviates from the normal face (e.g., based on the vertical attentiveness and horizontal attentiveness measurements). Examples disclosed herein compare the attentiveness metric to a threshold to determine if a person is attentive or not attentive to the media presentation in the environment. In examples disclosed herein, if the attentiveness metric does not satisfy (e.g., is greater than) the threshold, then examples disclosed herein determine the face (or the person) is not looking at the camera, or in other words is not attentive. Examples disclosed herein can do this separately as mentioned earlier for the vertical and horizontal planes.

Examples disclosed herein also normalize the distance measurements to the face’s width and height. By normalizing the distances, examples disclosed herein compute/measure the attentiveness metric of the face regardless of how close or far away the person is positioned to the camera. For example, examples disclosed herein do not need to have a separate threshold for bigger faces (e.g., faces closer to the camera) or smaller faces (e.g., faces far away from the camera). In some examples, if examples disclosed herein see a face in the distance but cannot properly identify who the subject is within a reasonable timeframe, examples disclosed herein automatically adjusts the camera controlled optical zoom and zoom the image (e.g., 2x if available). During the time the camera is zoomed, examples disclosed herein attempt facial recognition once more. After a certain timeout, examples disclosed herein un-zoom the camera back to the original (e.g., 1x). In the process of the optical camera zoom, if examples disclosed herein are able to (1) determine an attentiveness metric, (2) identify (e.g., using facial encodings) the subject with a high accuracy, and/or (3) determine the image isn’t blurry (e.g., using a blurry image detector), then such examples disclosed herein generate a new facial encoding for the particular face and add it to the existing library so examples disclosed herein can get a larger image library sample size for that face in the new environment (e.g., light, angle, etc.).

Examples disclosed herein additionally track faces as they move through the frame. Examples disclosed herein employ a generalized centroid tracker algorithm. Examples disclosed herein transmit captured frames from the camera to a face detector (e.g., a TRT-based MTCNN). After the face detector determines a list of bounding boxes with locations of faces (x1, y1, x2, y2), examples disclosed herein pass those coordinates to a tracker which calculates the centers (e.g., centroids) of the bounding boxes. Examples disclosed herein compare input frames to previous frames using a Euclidean distance formula. Some disclosed examples are based on an assumption that a given object will potentially move in between subsequent frames, but the distance between the centroids for frames will be smaller than distances between other objects. Once examples disclosed herein assign an object with an ID, examples disclosed herein can track that face between frames and know if the given person is attentive over time.

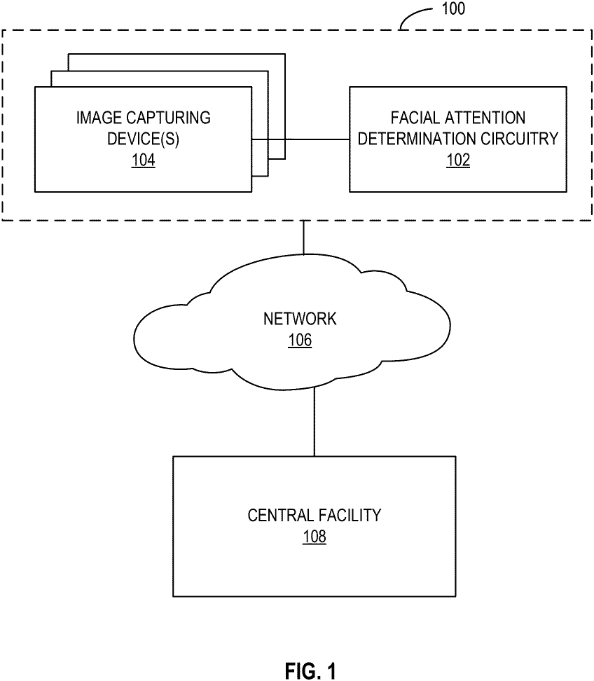

FIG. 1 is an example attention measuring circuitry 100 to measure attention of an audience member of media. The example attention measuring circuitry 100 includes example facial attention determination circuitry 102 and example image capturing device(s) 104. The example of FIG. 1 also includes an example network 106 and an example central facility 108.

In FIG. 1, the example attention measuring circuitry 100 measures an attention of one or more persons located in a media presentation environment. In some examples, the attention measurement circuitry 100 is a metering device to monitor media presented by media devices. In some examples, the attention measuring circuitry 100 identifies the media presented by the media devices and reports media monitoring information and audience attention data to an example central facility 108 of an example audience measurement entity via the example network 106. The example attention measuring circuitry 100 may be installed at a room of a household (e.g., a room in a home of a panelist, such as the home of a “Nielsen family”). In some examples, the attention measuring circuitry 100 includes the example image capturing device(s) 104. In some examples, the example attention measuring circuitry 100 does not include the example image capturing device(s) 104 and, instead, is communicatively coupled to the example image capturing device(s) 104. The example facial attention circuitry 102 is implemented at a household or at any media presentation environment in order to protect the privacy of panelists whose facial attention is being measured. For example, the central facility 108 obtains only the attention metric(s) (as described in further detail below) from the attention measuring circuitry 100 and does not obtain image data of panelists.

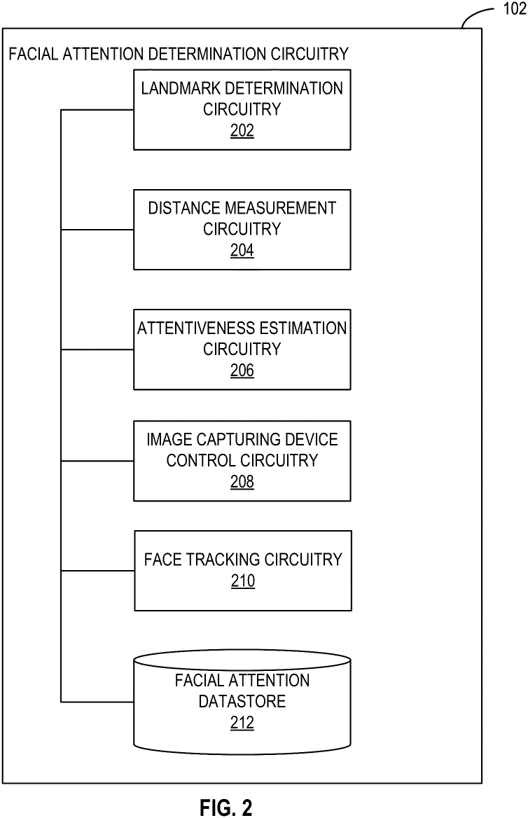

In FIG. 1, the example facial attention determination circuitry 102 measures and/or determines facial attention of faces identified in image data from the example image capturing device(s) 104. The example facial determination circuitry 102 is implemented by the example attention measuring circuitry 100. In some examples, the facial attention determination circuitry 102 may be implemented by a cloud computing server or service (e.g., an Amazon Web Services Simple Storage Service (AWS S3 server), a Microsoft Azure Cloud Service server, etc.). For example, the facial attention determination circuitry 102 may be a server owned and/or operated by a cloud computing provider. In additional or alternative examples, the facial attention determination circuitry 102 may be implemented by microprocessor circuitry executing instructions to implement one or more virtual machines and/or containers. For example, the facial attention determination circuitry 102 may be a containerized application including one or more containers that are in communication with one another. In some examples, the facial attention determination circuitry 102 is implemented by hardware circuitry such as an ASIC and/or an FPGA. The example facial attention determination circuitry 102 of FIG. 1 is described in further detail below in connection with FIG. 2.

In FIG. 1, the example image capturing device(s) 104 capture image frames of a media presentation environment. In some examples, the image capturing device(s) 104 are cameras, set up in a media presentation environment (e.g., a living room, a family room, a kitchen, etc.) atop a television, a set-top-box, and/or any type of media presenting device. Additionally and/or alternatively, the example image capturing device(s) 104 are positioned in any manner. In some examples, the image capturing device(s) 104 are implemented by media monitoring device(s), such as meter(s). For example, the image capturing device(s) 104 may be embedded in media monitoring device(s) and instructed, by the media monitoring device(s), to capture image frames of the media presentation device. In some examples, the image capturing device(s) 104 provide image data to the facial attention determination circuitry 102.

In FIG. 1, the example network 106 can be implemented by a wide area network (WAN) such as the Internet. However, in some examples, local networks may additionally or alternatively be used. Moreover, the example network 106 may be implemented using any type of public or private network such as, but not limited to, the Internet, a telephone network, a local area network (LAN), a cable network, and/or a wireless network, or any combination thereof.

In FIG. 1, the example central facility 108 is implemented by one or more servers. The central facility 108 processes and stores data received from the attention measuring circuitry 100 and/or the example facial attention determination circuitry 102. For example, the example central facility 108 of FIG. 1 combines attention measurement data and program identification data from multiple households to generate aggregated media monitoring information. The central facility 108 generates a report(s) for advertisers, program producers and/or other interested parties based on the compiled statistical data. Such reports include extrapolations about the size and demographic composition of audiences of content, channels and/or advertisements based on the demographics and behavior of the monitored panelists.

FIG. 2 is a block diagram of the example facial attention determination circuitry 102 of FIG. 1. The example facial attention determination circuitry 102 of FIGS. 1 and 2 may be instantiated (e.g., creating an instance of, bring into being for any length of time, materialize, implement, etc.) by processor circuitry such as a central processing unit executing instructions. Additionally or alternatively, the example facial attention determination circuitry 102 of FIGS. 1 and 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. As described above, in some examples, some or all of the circuitry of FIG. 2 may be implemented by one or more virtual machines and/or containers executing on the microprocessor.

The example facial attention determination circuitry 102 includes example landmark determination circuitry 202, example distance measurement circuitry 204, example attentiveness estimation circuitry 206, example image capturing device control circuitry 208, example face tracking circuitry 210, and an example facial attention datastore 212.

In FIG. 2, the example landmark determination circuitry 202 determines facial landmarks from input image data. As used herein, facial landmarks are coordinates corresponding to a human’s eyes, nose, mouth, etc. For example, five facial landmarks determined by the landmark determination circuitry 202 include coordinates for the left eye, the right eye, the nose, the left mouth corner/position, and the right mouth corner/position of a detected face. In some examples, the landmark determination circuitry 202 determines any number of facial landmarks. For example, the landmark determination circuitry 202 may determine regions of the face, such as landmark points that make up the shape of the nose, landmark points that make up the shape of the mouth, etc. In some examples, to determine the facial landmarks from input image data, the landmark determination circuitry 202 first detects a face. For example, the landmark determination circuitry 202 locates a human face from the input image data and returns a value in terms of the coordinates of a bounding rectangle of the detected face.

In FIG. 2, the example landmark determination circuitry 202 is a Multi-task Cascade Convolutional Neural Network (MTCNN) facial detector. A MTCNN is a human face detection architecture which uses a cascaded structure with three stages. The three stages of the MTCNN include a Proposal-Net (P-Net), a Refinement-Net (R-Net), and an Overall-Net (O- Net). The P-Net is a fully convolutional CNN that produces candidate windows of faces through a sliding scan on an input image in different scales. The R-Net refines the candidate windows, output by the P-Net, by bounding box regression and rejects any remaining false alarm candidate windows. The O-Net obtains the refined candidate windows and determines the coordinates of the bounding box, the coordinates of the five facial landmarks, and a confidence level of each box. A confidence level of each bounding box is a numerical value indicative of a probability that a face is within the bounds of the box and that the landmarks determined accurately represent the facial feature in that box.

In some examples, the landmark determination circuitry 202 is unable to identify and/or detect a face. In some examples, such a failure may be due to the image capturing device(s) 104 of FIG. 1 providing pixelated, low resolution image frames. In some examples, such a failure may be due to an audience member being a distance away from the image capturing device(s) 104 in the media presentation environment. In such examples, the landmark determination circuitry 202 may notify the image capturing device control circuitry 208 to adjust the image capturing device(s) 104.

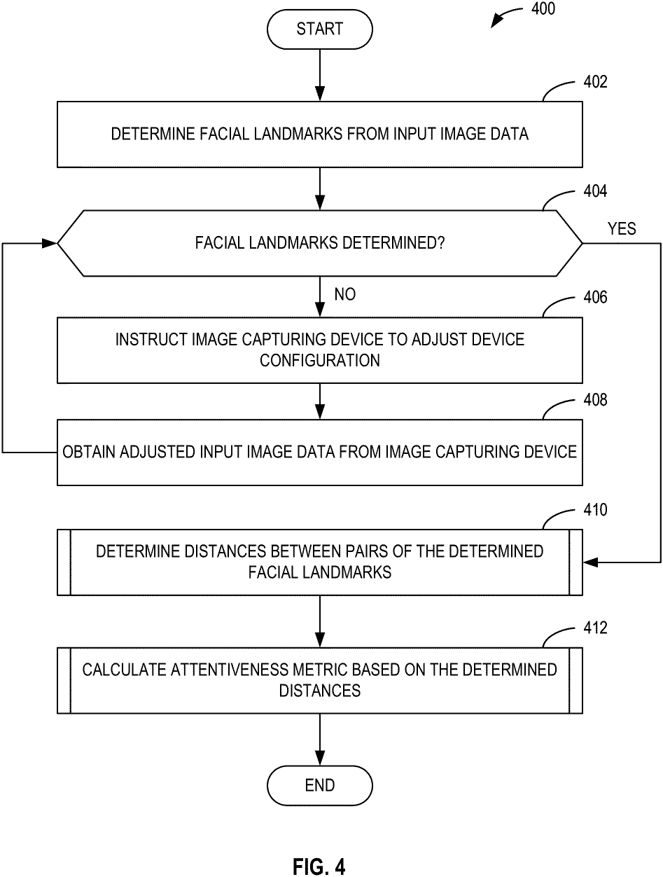

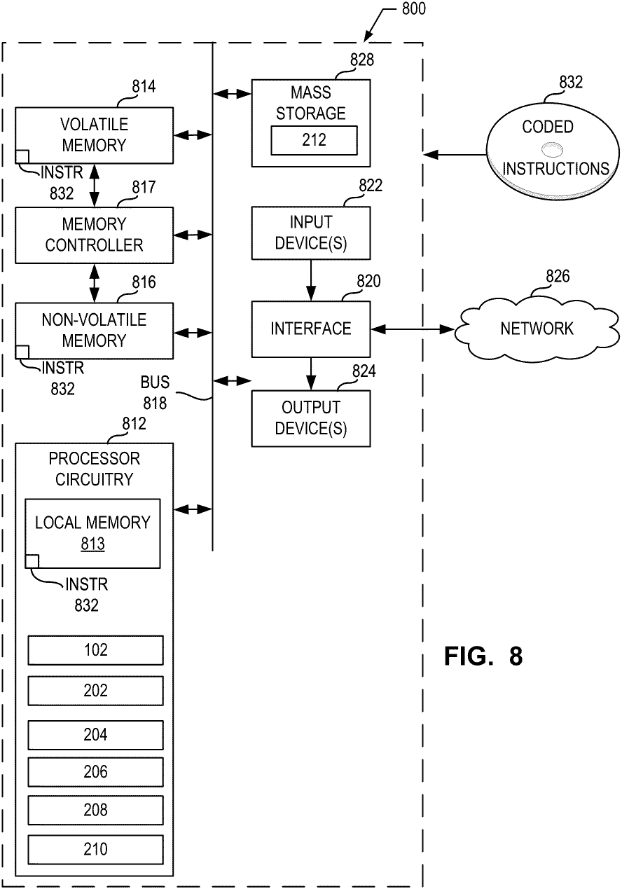

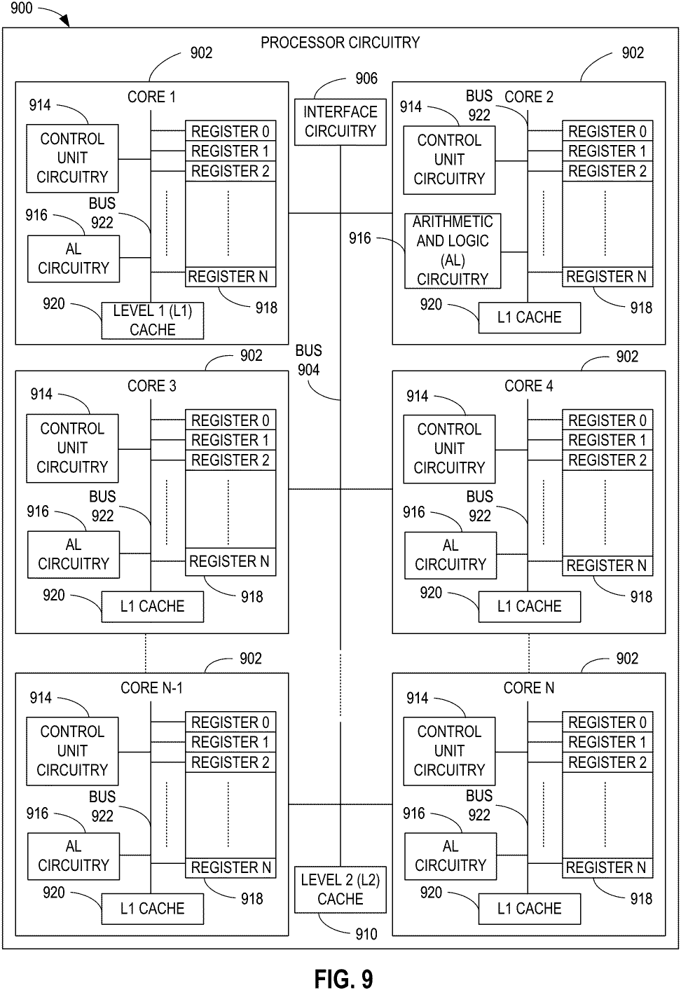

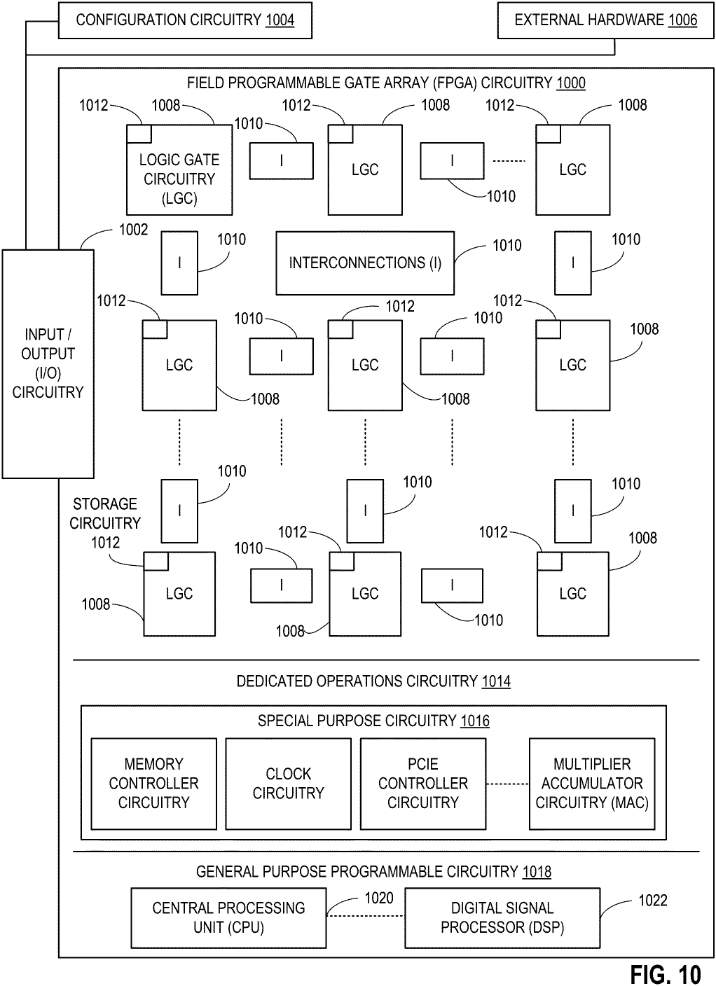

In some examples, the facial attention determination circuitry 102 includes means for determining facial landmarks from input image data. For example, the means for determining facial landmarks from input image data may be implemented by landmark determination circuitry 202. In some examples, the landmark determination circuitry 202 may be instantiated by processor circuitry such as the example processor circuitry 812 of FIG. 8. For instance, the landmark determination circuitry 202 may be instantiated by the example microprocessor 900 of FIG. 9 executing machine executable instructions such as those implemented by at least blocks 402, 404 of FIG. 4. In some examples, the landmark determination circuitry 202 may be instantiated by hardware logic circuitry, which may be implemented by an ASIC, XPU, or the FPGA circuitry 1000 of FIG. 10 structured to perform operations corresponding to the machine readable instructions. Additionally or alternatively, the landmark determination circuitry 202 may be instantiated by any other combination of hardware, software, and/or firmware. For example, the landmark determination circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In FIG. 2, the example distance measurement circuitry 204 determines distances between pairs of the determined facial landmarks. Such distances are also referred to as facial landmark distances or, more succinctly, landmark distances. In some examples, the distance measurement circuitry 204 determines the distances from a facial landmark representative of a nose to the other four facial landmarks. For example, the distance measurement circuitry 204 measures the distance between the facial landmark representative of the nose and a facial landmark representative of the left corner of the mouth (e.g., nose-to-left lip) to determine a first distance. The example distance measurement circuitry 204 measures the distance between the facial landmark representative of the nose and a facial landmark representative of the right corner of the mouth (e.g., nose-to-right lip) to determine a second distance. The example distance measurement circuitry 204 measures the distance between the facial landmark representative of the nose and a facial landmark representative of the left eye (e.g., nose-to-left eye) to determine a third distance. The example distance measurement circuitry 204 measures the distance between the facial landmark representative of the nose and a facial landmark representative of the right eye (e.g., nose-to-right eye) to determine a fourth distance. The example distance measurement circuitry 204 determines a first segment between the facial landmarks representative of the corners of the mouth. In some examples, the distance measurement circuitry 204 utilizes the first segment between the corners of the mouth and the nose facial landmark to determine a fifth distance. For example, the distance measurement circuitry 204 determines a nose-to-center of mouth distance (e.g., fifth distance) using the facial landmark representative of the nose and the first segment. The example distance measurement circuitry 204 determines a second segment between the facial landmarks representative of the left eye and right eye. In some examples, the distance measurement circuitry 204 utilizes the second segment, and the nose facial landmark, to determine a sixth distance. For example, the distance measurement circuitry 204 determines a nose-to-center of two eyes distance (e.g., sixth distance) using the facial landmark representative of the nose and the second segment. The example distance measurement circuitry 204 stores the determined distances in the example facial attention datastore 212.

In some examples, the distance measurement circuitry 204 measures these facial landmark distances by determining a Euclidean distance between two landmark points. For example, the landmark points may be Cartesian coordinates that indicate a location of a facial feature relative to a fixed reference point (e.g., an origin) on two fixed axes (e.g., an x-axis and a y-axis). In some examples, the distance measurement circuitry 204 applies a Euclidean distance algorithm to the two sets of coordinates (e.g., the facial landmark points) to determine the distance between the two sets of coordinates. Additionally and/or alternatively, the example distance measurement circuitry 204 utilizes any type of distance measuring algorithm to determine the distance between two facial landmarks.

In some examples, the distance measurement circuitry 204 normalizes the determined facial landmark distances. For example, not every detected face will be the same size due to the distance between the image capturing device(s) 104 and the audience member(s). In such examples, it may be computationally intensive to require the facial attention determination circuitry 102 to store separate thresholds for bigger faces (e.g., faces closer to the camera) and smaller faces (e.g., faces far away from the camera) and determine which of those thresholds to compare to the determined facial landmark distances. Therefore, in some examples, the distance measurement circuitry 204 normalizes the determined facial landmark distances to the face’s overall width and height. For example, the distance measurement circuitry 204 determines a width of the detected face and a height of the detected face. Then the example distance measurement circuitry 204 determines an area of the detected face based on the width and height. In some examples, the distance measurement circuitry 204 uses the facial landmark distances and the area of the face to normalize the facial landmark distances. For example, the distance measurement circuitry 204 normalizes facial landmark distances by dividing a facial landmark distance by a square root of the area of the detected face. In some examples, the distance measurement circuitry 204 does not normalize the computed distances.

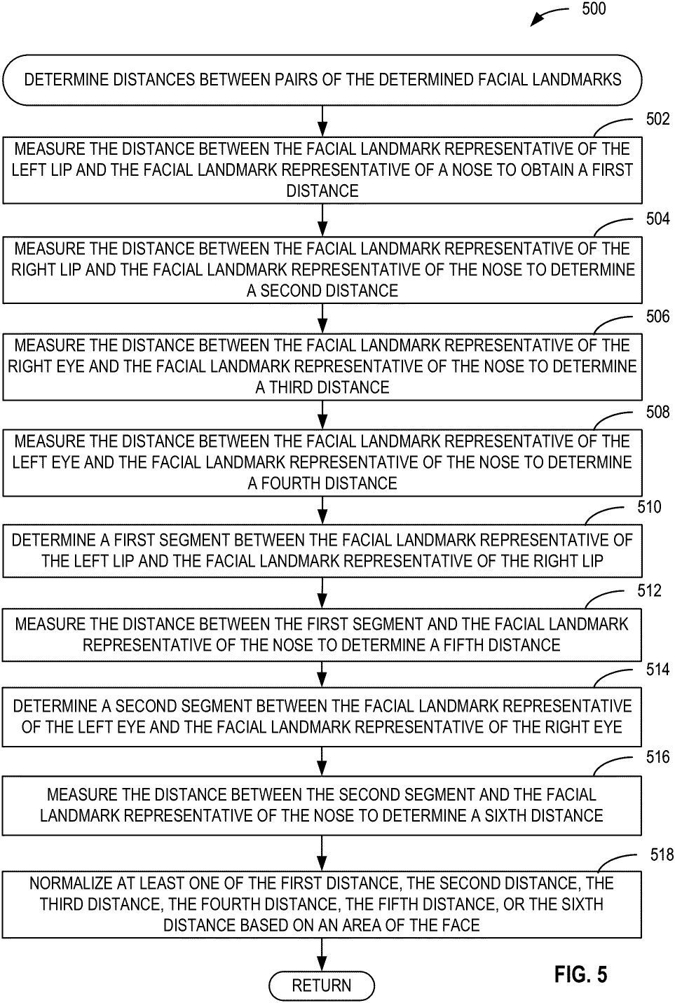

In some examples, the facial attention determination circuitry 102 includes means for determining distances between each of the determined facial landmarks. For example, the means for determining distances between each of the facial landmarks may be implemented by distance measurement circuitry 204. In some examples, the distance measurement circuitry 204 may be instantiated by processor circuitry such as the example processor circuitry 812 of FIG. 8. For instance, the distance measurement circuitry 204 may be instantiated by the example microprocessor 900 of FIG. 9 executing machine executable instructions such as those implemented by at least block 410 of FIG. 4 and/or blocks 502, 504, 506, 508, 510, 512, 514, 516, and 518 of FIG. 5. In some examples, the distance measurement circuitry 204 may be instantiated by hardware logic circuitry, which may be implemented by an ASIC, XPU, or the FPGA circuitry 1000 of FIG. 10 structured to perform operations corresponding to the machine readable instructions. Additionally or alternatively, the distance measurement circuitry 204 may be instantiated by any other combination of hardware, software, and/or firmware. For example, the distance measurement circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In FIG. 2, the example attentiveness estimation circuitry 206 determines an attentiveness metric based on the determined distances. The example attentiveness estimation circuitry 206 determines the attentiveness metric by calculating a quotient of two determined distances and comparing the quotient to a pre-defined threshold. For example, the attentiveness estimation circuitry 206 divides the nose-to-left eye distance by the nose-to-right eye distance to obtain a first quotient. In some examples, the attentiveness estimation circuitry 206 compares the first quotient to a first threshold to obtain the attentiveness metric. In some examples, the first threshold is indicative of the greatest amount of side skew from a neutral face before the face is identified as distracted (or not attentive). As used herein, the side skew refers to a deviation of the nose to eyes from nose to eyes of a neutrally positioned face. For example, the image capturing device(s) 104 capture image data of an audience member from one position. If the audience member is facing towards the image capturing device(s) 104, the distance between the nose-to-left eye should be equal or approximately equal (e.g., within some tolerance) to the distance between the nose-to-right eye. However, if the audience member is facing away from the image capturing device(s) 104 (e.g., turned to the left with respect to the image capturing device(s) 104 or turned to the right with respect to the image capturing device(s) 104), the distance between the nose-to-left eye would be greater than or less than the distance between the nose-to-right eye. In such an example, the attentiveness estimation circuitry 206 determines that the quotient represents a side skew.

In some examples, the attentiveness estimation circuitry 206 divides the nose-to-left lip distance by the nose-to-right lip distance to obtain a second quotient. In some examples, the attentiveness estimation circuitry 206 compares the second quotient to a second threshold to obtain the attentiveness metric. In some examples, the second threshold is indicative of the greatest amount of side skew from a neutral face before the face is identified as distracted (or not attentive). In some examples, the attentiveness estimation circuitry 206 uses both the first quotient and the second quotient to measure side skew. For example, using both the first quotient and the second quotient might increase and/or improve an accuracy of determining a side skew metric. Alternatively, the attentiveness estimation circuitry 206 uses one quotient (e.g., the first quotient or the second quotient) to determine the side skew.

In some examples, the attentiveness estimation circuitry 206 divides the nose-to-center of two eyes distance (e.g., sixth distance) by the nose-to-center of mouth distance (e.g., fifth distance) to obtain a third quotient. In some examples, the attentiveness estimation circuitry 206 compares the third quotient to a third threshold to obtain the attentiveness metric. In some examples, the third threshold is indicative of the greatest amount of up skew or down skew from a neutral face before the face is identified as distracted (or not attentive). As used herein, the up and/or down skew refers to a deviation of the nose with respect to the mouth and the eyes relative to a neutrally positioned face. For example, if the audience member is facing towards the image capturing device(s) 104, the distance between the nose-to-center of two eyes distance should be approximately equal to the distance between the nose-to-center of mouth. However, if the audience member is looking up or down, the distance between the nose-to-center of the two eyes should be a threshold greater than or a threshold less than the distance between the nose-to-center of the mouth. In such an example, the attentiveness estimation circuitry 206 determines that the quotient represents a an up or down skew.

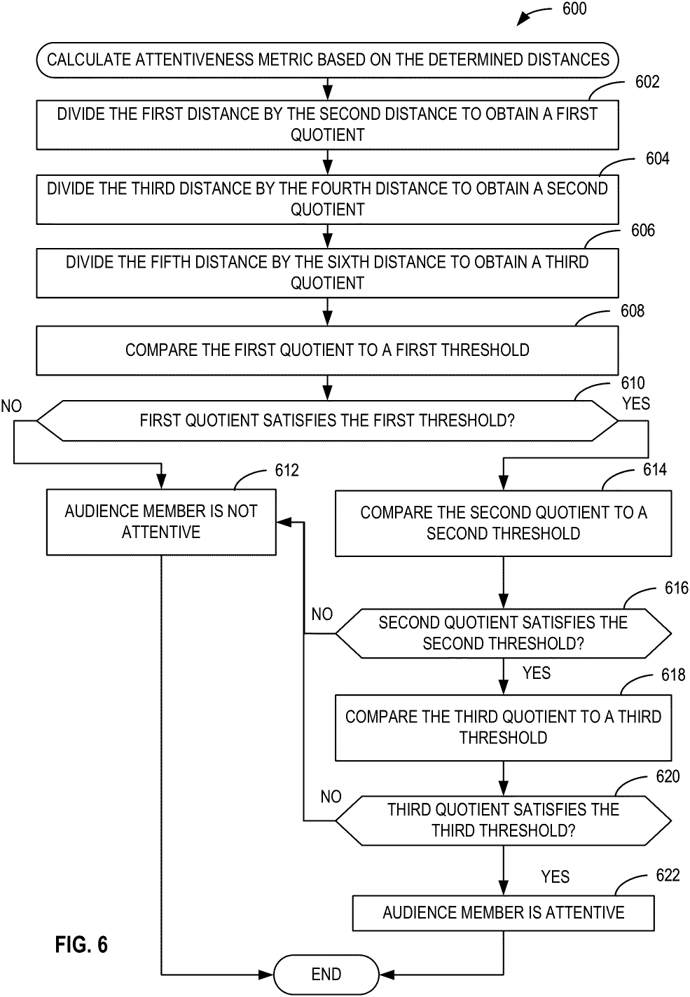

In some examples, the facial attention determination circuitry 102 includes means for determining an attentiveness metric based on the determined distances. For example, the means for determining an attentiveness metric may be implemented by attentiveness estimation circuitry 206. In some examples, the attentiveness estimation circuitry 206 may be instantiated by processor circuitry such as the example processor circuitry 812 of FIG. 8. For instance, the attentiveness estimation circuitry 206 may be instantiated by the example microprocessor 900 of FIG. 9 executing machine executable instructions such as those implemented by at least block 412 of FIG. 4 and/or blocks 602, 604, 606, 608, 610, 612, 614, 616, 618, 620, 622 of FIG. 6. In some examples, the attentiveness estimation circuitry 206 may be instantiated by hardware logic circuitry, which may be implemented by an ASIC, XPU, or the FPGA circuitry 1000 of FIG. 10 structured to perform operations corresponding to the machine readable instructions. Additionally or alternatively, the attentiveness estimation circuitry 206 may be instantiated by any other combination of hardware, software, and/or firmware. For example, the attentiveness estimation circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In FIG. 2, the example image capturing device control circuitry 208 adjusts a configuration of the image capturing device(s) 104 (see FIG. 1). For example, the image capturing device control circuitry 208 adjusts a lens and/or adjusts an exposure configuration of the image capturing device(s) 104. In some examples, the image capturing device(s) 104 may not capture images of the media presentation environment that are suitable for data gathering (e.g., for measuring attentiveness). In such an example, the image capturing device control circuitry 208 detects when the image capturing device(s) 104 is/are not capturing suitable image data and sends instructions to the image capturing device(s) 104 to adjust the lens and/or brightness to capture image data. In some examples, the image capturing device control circuitry 208 determines when the image capturing device(s) 104 is/are not capturing suitable data when the landmark determination circuitry 202 does not identify facial landmarks. For example, the landmark determination circuitry 202 may identify a bounding box, but not determine the facial landmarks within the bounding box. In some examples, this can be due to the audience member being too far away from the image capturing device(s) 104. In some examples, facial landmarks may not be determined due to exposure (e.g., brightness) of the image being too low. In such examples, the landmark determination circuitry 202 may notify the image capturing device control circuitry 208 that image data needs to be recaptured due to a failure in identifying facial landmarks.

In some examples, the image capturing device control circuitry 208 uses a generalized brightness algorithm to detect and measure the exposure of the image with undetermined facial landmarks to determine how to control the image capturing device(s) 104. For example, the image capturing device control circuitry 208 determines, based on the generalized brightness algorithm, that the exposure of the image is too low and causes the image capturing device(s) 104 to adjust the exposure to the desired lumens. In some examples, if the image capturing device control circuitry 208 determines, based on the generalized brightness algorithm, that the exposure of the image is not satisfactory (e.g., not too low and/or not too high), then the image capturing device control circuitry 208 may determine that the lens of the image capturing device(s) 104 needs to be adjusted. For example, if the image data includes a face, but the face is in the distance (e.g., too far from the image capturing device(s) 104), the image capturing device control circuitry 208 causes the image capturing device(s) 104 to zoom in on the face. In some examples, when the image capturing device(s) 104 zoom the image data, the image capturing device control circuitry 208 waits for feedback from the landmark determination circuitry 202. For example, the landmark determination circuitry 202 obtains new image data in response to the lens of the image capturing device(s) 104 being adjusted (e.g., zoomed in). In such an example, the landmark determination circuitry 202 makes a determination of facial landmarks in the new image data. As such, the example image capturing device control circuitry 208 obtains a response and/or a notification from the landmark determination circuitry 202 indicative of whether facial landmarks were determined. In some examples, if the landmark determination circuitry 202 cannot identify facial landmarks in the new image data, then the image capturing device control circuitry 208 is notified and attempts to readjust the image capturing device(s) 104 until the image data is suitable (e.g., is bright enough, is close enough, etc.) for processing.

In some examples, the facial attention determination circuitry 102 includes means for adjusting a configuration of an image capturing device. For example, the means for adjusting a configuration of an image capturing device may be implemented by image capturing device control circuitry 208. In some examples, the image capturing device control circuitry 208 may be instantiated by processor circuitry such as the example processor circuitry 812 of FIG. 8. For instance, the image capturing device control circuitry 208 may be instantiated by the example microprocessor 900 of FIG. 9 executing machine executable instructions such as those implemented by at least blocks 404, 406 of FIG. 4. In some examples, the image capturing device control circuitry 208 may be instantiated by hardware logic circuitry, which may be implemented by an ASIC, XPU, or the FPGA circuitry 1000 of FIG. 10 structured to perform operations corresponding to the machine readable instructions. Additionally or alternatively, the image capturing device control circuitry 208 may be instantiated by any other combination of hardware, software, and/or firmware. For example, the image capturing device control circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In FIG. 2, the example face tracking circuitry 210 tracks faces detected in captured image frames of a media presentation environment. In some examples, the face tracking circuitry 210 enables the facial attention determination circuitry 102 to track the attentiveness of an audience member. For example, the landmark determination circuitry 202 may obtain two frames representative of faces and determine facial landmarks for both of the frames. However, the landmark determination circuitry 202 does not identify which face belongs to which audience member in the context of the previous frame before that. The example face tracking circuitry 210 tracks the frames to correlate the attention from one frame to the next and generates a history of the detected faces over time.

In this example, the face tracking circuitry 210 employs a generalized centroid tracker algorithm to track the faces of audience members. The example image capturing device(s) 104 transmit captured frames to the example face tracking circuitry 210. The example face tracking circuitry 210 determines a list of coordinates that make up bounding boxes associated with locations of faces (e.g., where x1, y1 corresponds to the x and y coordinates of the top left corner of the bounding box, and wherein x2, y2 corresponds to the x and y coordinate of the bottom right corner of the rectangle). The example face tracking circuitry 210 determines (e.g., calculates) the center coordinates for the bounding boxes. For example, in a bounding box, the center coordinate corresponds to a center location in the bounding box on a fixed axis. The example face tracking circuitry 210 assigns an object identifier to each center coordinate. For example, each bounding box corresponds to a different and/or unique face in the media presentation environment. Therefore, a different object identifier is assigned to each different center coordinate. The example face tracking circuitry 210 stores the center coordinates and the object identifier in the example facial attention datastore 212. For subsequent captured frames, the face tracking circuitry 210 determines the new center coordinates (e.g., centroid) of the detected face bounding boxes and compares the new center coordinates to the ones stored in the example facial attention datastore 212. For example, the face tracking circuitry 210 compares bounding box center coordinates in a captured frame to the bounding box center coordinates in the previous frame using a Euclidean distance formula. It is assumed that a given object (e.g., a face of an audience member) will potentially move in between subsequent frames, but the distance between the centroids for the same faces among successive frames will be smaller than all other distances between objects (e.g., other distances calculated between centroids of successive frames). Therefore, the example face tracking circuitry 210 determines, based on the comparison, whether the new center coordinate is associated with any of the previous center coordinates. In some examples, the face tracking circuitry 210 compares the distance between center coordinates of bounding boxes in successive frames to a distance threshold. In some examples, the distance threshold is indicative of a maximum distance between center coordinates before the center coordinates do not correspond to the same object. In some examples, if the face tracking circuitry 210 determines the distance between two center coordinates does not satisfy the threshold, then the face tracking circuitry 210 assigns a unique object identifier to the center coordinate corresponding to the most recent frame that is different from the object identifier of the center coordinate corresponding to a previous frame. In some examples, if the face tracking circuitry 210 determines the distance between two center coordinates of bounding boxes in successive frames satisfies the threshold, then the face tracking circuitry 210 assigns the same object identifier used in the preceding frame to the center coordinate corresponding to the most recent frame.

In some examples, the face tracking circuitry 210 stores the center coordinates and respective object identifiers in the facial attention datastore 212 so that the attentiveness estimation circuitry 206 can determine whether the given person is attentive over time. In some examples, the face tracking circuitry 210 makes the attentive measurement dynamic.

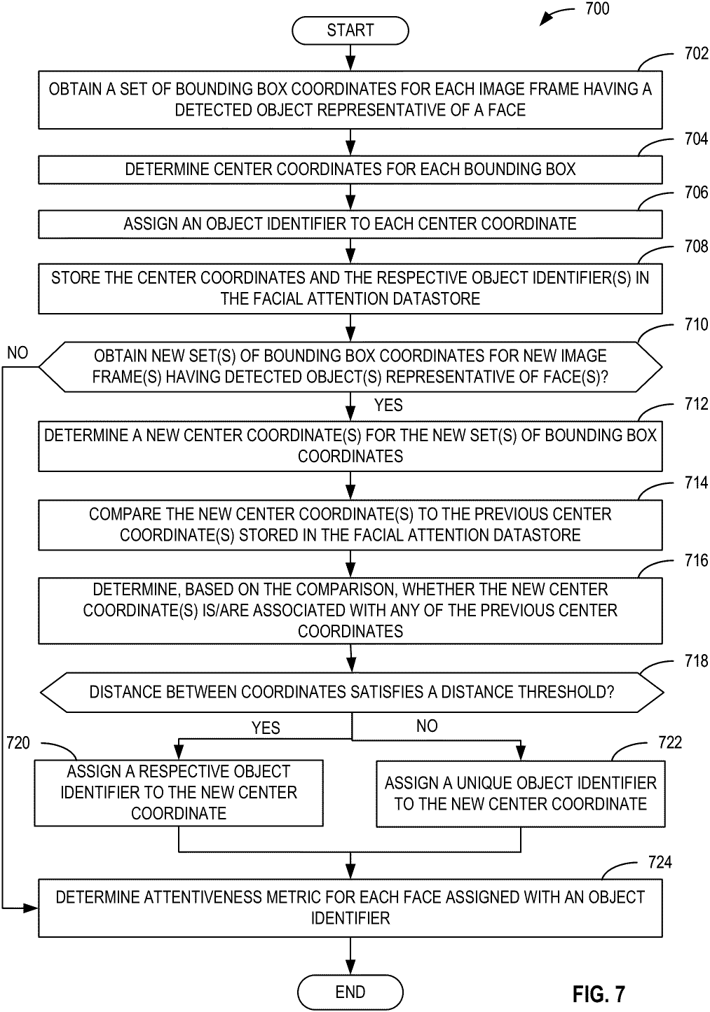

In some examples, the facial attention determination circuitry 102 includes means for tracking faces in a media presentation environment. For example, the means for tracking faces in a media presentation environment may be implemented by face tracking circuitry 210. In some examples, the face tracking circuitry 210 may be instantiated by processor circuitry such as the example processor circuitry 812 of FIG. 8. For instance, the face tracking circuitry 210 may be instantiated by the example microprocessor 900 of FIG. 9 executing machine executable instructions such as those implemented by at least blocks 702, 704, 706, 708, 710, 712, 714, 716, 718, 720, 722, 724 of FIG. 7. In some examples, the face tracking circuitry 210 may be instantiated by hardware logic circuitry, which may be implemented by an ASIC, XPU, or the FPGA circuitry 1000 of FIG. 10 structured to perform operations corresponding to the machine readable instructions. Additionally or alternatively, the face tracking circuitry 210 may be instantiated by any other combination of hardware, software, and/or firmware. For example, the face tracking circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In FIG. 2, the example facial attention datastore 212 stores attentiveness measurement data, face tracking data, and image data. For example, the facial attention datastore 212 stores center coordinates and object identifiers provided by the face tracking circuitry 210, image data captured by image capturing device(s) 104, attentiveness data determined by the attentiveness estimation circuitry 206, facial landmarks determined by the landmark determination circuitry 202, and distance measurements determined by the distance measurement circuitry 204. In some examples, the facial attention datastore 212 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The facial attention datastore 212 can additionally or alternatively be implemented by one or more double data rate (DDR) memories, such as DDR, DDR2, DDR3, DDR4, mobile DDR (mDDR), etc. The facial attention datastore 212 can additionally or alternatively be implemented by one or more mass storage devices such as hard disk drive(s), compact disk drive(s), digital versatile disk drive(s), solid-state disk drive(s), etc. While in the illustrated example the facial attention datastore 212 is illustrated as a single datastore, the facial attention datastore 212 can be implemented by any number and/or type(s) of datastores. Furthermore, the data stored in the facial attention datastore 212 can be in any data format such as, for example, binary data, comma delimited data, tab delimited data, structured query language (SQL) structures, etc.

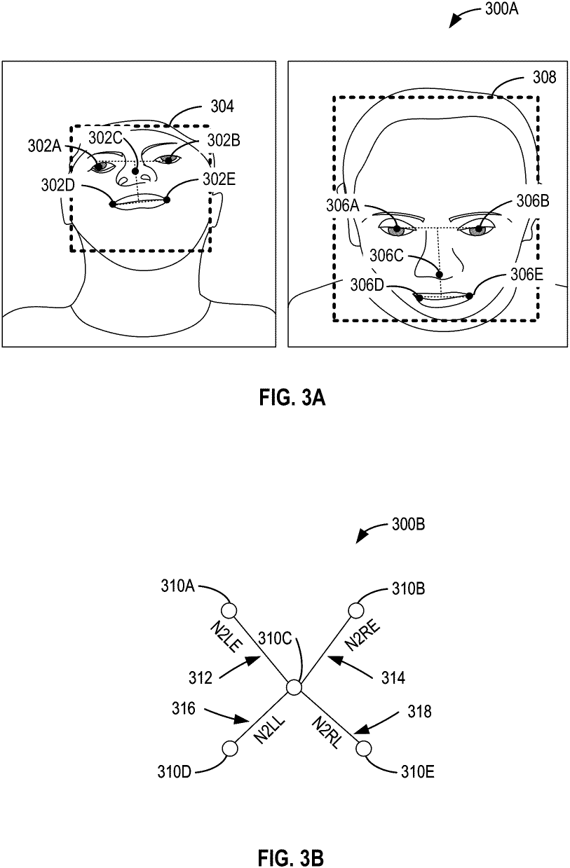

FIGS. 3A and 3B depict example illustrations of facial landmarks. FIG. 3A is a first illustration 300A of example first facial landmarks 302A, 302B, 302C, 302D, 302E in an example first bounding box 304 and example second facial landmarks 306A, 306B, 306C, 306D, 306E in an example second bounding box 308. FIG. 3B is a second illustration 300B of example third facial landmarks 310A, 310B, 310C, 310D, 310E.

In FIG. 3A, the example first facial landmarks 302A, 302B, 302C, 302D, 302E correspond to a left eye 302A, a right eye 302B, a nose 302C, a left lip 302D, and a right lip 302E. In some examples, the landmark determination circuitry 202 (FIG. 2) determines the example first facial landmarks 302A, 302B, 302C, 302D, 302E. The example first bounding box 304 corresponds to a face detected in a first frame captured by an example image capturing device(s) 104 (FIG. 1). In some examples, the face tracking circuitry 210 (FIG. 2) identifies the center coordinate of the first bounding box 304 and stores the center coordinate in the facial attention datastore 212 (FIG. 2).

In FIG. 3A, the example second facial landmarks 306A, 306B, 306C, 306D, 306E correspond to a left eye 306A, a right eye 306B, a nose 306C, a left lip 306D, and a right lip 306E. The example second bounding box 308 corresponds to a face detected in a second frame captured by the example image capture device(s) 104. In some examples, the second facial landmarks 306A, 306B, 306C, 306D, 306E correspond to the first facial landmarks 302A, 302B, 302C, 302D, 302E, respectively. For example, assume that the face tracking circuitry 210 determines that the face detected in the second frame is the same face as the one detected in the first frame. Therefore, the first facial landmarks 302A, 302B, 302C, 302D, 302E and the second facial landmarks 306A, 306B, 306C, 306D, 306E correspond to the same left eye, right eye, nose, left lip, and right lip.

In FIG. 3A, the example distance measurement circuitry 204 (FIG. 2) measures distances between the first facial landmarks 302A, 302B, 302C, 302D, 302E. For example, the distance measurement circuitry 204 a first segment between the left eye facial landmark 302A and the right eye facial landmark 302B, a second segment between the left lip facial landmark 302D and the right lip facial landmark 302E, a first distance between the nose landmark 302C and the first segment, and a second distance between the nose landmark 302C and the second segment.

In FIG. 3A, the example distance measurement circuitry 204 measures distances between the second facial landmarks 306A, 306B, 306C, 306D, 306E. For example, the distance measurement circuitry 204 determines a third segment between the left eye facial landmark 306A and the right eye facial landmark 306B, a fourth segment between the left lip facial landmark 306D and the right lip facial landmark 306E, a third distance between the nose landmark 302C and the third segment, and a fourth distance between the nose landmark 306C and the fourth segment.

In some examples, the attentiveness estimation circuitry 206 determines an attentiveness metric for the first bounding box 304 and the second bounding box 308. In FIG. 3A, the face detected in the first bounding box 304 is looking up. The example attentiveness estimation circuitry 206 determines that the face is not attentive (or distracted) because a quotient of the first distance (corresponding to the distance between the nose landmark 302C and the first segment) and the second distance (corresponding to the distance between the nose landmark 302C and the second segment) is less than a threshold. For example, the first distance is less than the second distance. If the detected face were attentive, the first distance and the second distance may be substantially equal after the distances were normalized.

In FIG. 3A, the face detected in the second bounding box 308 is looking down. The example attentiveness estimation circuitry 206 determines that the face is not attentive or distracted (e.g., looking down) because a quotient of the third distance (corresponding to the distance between the nose landmark 306C and a center of the eyes) and the fourth distance (corresponding to the distance between the nose landmark 306C and a center of the lips) is greater than a threshold. For example, the third distance is greater than the fourth distance. If the detected face were attentive, the third distance and the fourth distance may be substantially equal after the distances were normalized.

In FIG. 3B, the example second illustration 300B includes the example third facial landmarks 310A, 310B, 310C, 310D, 310E. In some examples, the third facial landmarks 310A, 310B, 310C, 310D, 310E correspond to a left eye facial landmark 310A, a right eye facial landmark 310B, a nose facial landmark 310C, a left lip facial landmark 310D, and a right lip facial landmark 310E. In some examples, the landmark determination circuitry 202 determines the third facial landmarks 310A, 310B, 310C, 310D, 310E.

In FIG. 3B, the distance measurement circuitry 204 measures distances 312, 314, 316, and 318 between the third facial landmarks 310A, 310B, 310C, 310D, 310E. In this example, the distance measurements 312, 314, 316, and 318 are different than the distance measurements of FIG. 3A. For example, in FIG. 3A, the distance measurement circuitry 204 calculates the fifth and sixth distances to determine up/down skew while, in FIG. 3B, the distance measurement circuitry 204 calculates the first, second, third, and fourth distances to determine side skew.

For example, the distance measurement circuitry 204 determines a first distance 312 between the nose landmark 310C and the left eye landmark 310A (n2le). The example distance measurement circuitry 204 determines a second distance 314 between the nose landmark 310C and the right eye landmark 310B (n2re). The example distance measurement circuitry 204 determines a third distance 316 between the nose landmark 310C and the left lip landmark 310D (n211). The example distance measurement circuitry 204 determines a fourth distance 318 between the nose landmark 310C and the right lip landmark 310E (n2rl).

In some examples, the attentiveness estimation circuitry 206 determines whether the face, corresponding to the third facial landmarks 310A, 310B, 310C, 310D, 310E, is attentive or not attentive (e.g., distracted) based on the example distances 312, 314, 316, and 318. For example, the attentiveness estimation circuitry 206 determines that an audience member is looking left or right (e.g., is turned away from the image capturing device(s) 104) by dividing the first distance 312 by the second distance 314 and comparing the result to a threshold. For example, if the first distance 312 is not equal or substantially equal (e.g., within a tolerance) to the second distance 314, then it is likely that the audience member corresponding to the third facial landmarks 310A, 310B, 310C, 310D, 310E is not attentive (e.g., is distracted). Similarly, the example attentiveness estimation circuitry 206 determines that an audience member is looking left or right by dividing the third distance 316 by the fourth distance 318 and comparing the result to a threshold. For example, if the third distance 316 is not equal to and/or substantially equal to the fourth distance 318, then it is likely that the audience member corresponding to the third facial landmarks 310A, 310B, 310C, 310D, 310E is distracted.

While an example manner of implementing the facial attention determination circuitry 102 of FIG. 1 is illustrated in FIG. 2, one or more of the elements, processes, and/or devices of examples disclosed herein may be combined, divided, re-arranged, omitted, eliminated, and/or implemented in any other way. Further, the example landmark determination circuitry 202, the example distance measurement circuitry 204, the example attentiveness estimation circuitry 206, the example image capturing device control circuitry 208, the example face tracking circuitry 210, the example facial attention datastore 212, and/or, more generally, the example facial attention determination circuitry 102 of FIG. 1, may be implemented by hardware alone or by hardware in combination with software and/or firmware. Thus, for example, any of the example landmark determination circuitry 202, the example distance measurement circuitry 204, the example attentiveness estimation circuitry 206, the example image capturing device control circuitry 208, the example face tracking circuitry 210, the example facial attention datastore 212, and/or, more generally, the example facial attention determination circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example facial attention determination circuitry 102 of FIG. 1 may include one or more elements, processes, and/or devices in addition to, or instead of, those illustrated in FIG. 1, and/or may include more than one of any or all of the illustrated elements, processes and devices.

Flowcharts representative of example hardware logic circuitry, machine readable instructions, hardware implemented state machines, and/or any combination thereof for implementing the facial attention determination circuitry 102 of FIG. 1 is shown in FIGS. 4-7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 4-7, many other methods of implementing the example facial attention determination circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to implement the example facial attention determination circuitry 102 of FIGS. 1 and 2. The machine readable instructions and/or the operations 400 of FIG. 4 begin at block 402, at which the example landmark determination circuitry 202 determines facial landmarks from input image data. For example, the landmark determination circuitry 202 obtains image data of a media presentation environment from image capturing device(s) 104 (FIG. 1). The image data includes one or more faces of audience members detected in the media presentation environment. The example landmark determination circuitry 202 identifies facial landmarks of the one or more faces of audience members.

At block 404, the example image capturing device control circuitry 208 (FIG. 2) determines whether facial landmarks were determined. For example, the image capturing device control circuitry 208 obtains a notification from the landmark determination circuitry 202 when the input image data is not suitable (e.g., low exposure, captured face is too small due to being farther away from the image capturing device(s) 104, etc.) for identifying facial landmarks. In some examples, the image capturing device control circuitry 208 determines whether facial landmarks are determined by querying the landmark determination circuitry 202. For example, the image capturing device control circuitry 208 may query the landmark determination circuitry 202 for an update on whether facial landmarks were determined in the input image data.

In some examples, if the image capturing device control circuitry 208 determines that facial landmarks were not determined (block 404: NO), then the example image capturing device control circuitry 208 instructs the image capturing device(s) 104 to adjust a device configuration (block 406). For example, the image capturing device control circuitry 208 causes the image capturing device(s) 104 to change an exposure setting, adjust a focal length of the image capturing device(s) 104, etc.

At block 408, the example landmark determination circuitry 202 obtains adjusted input image data from the example image capturing device(s) 104. For example, the image capturing device(s) 104 capture image data in response to the adjustment of device configuration. For example, if the focal length of the lens is adjusted to zoom in on the media presentation environment, then the image capturing device(s) 104 capture zoomed-in image data of the media presentation environment. Control returns to block 404, where the example image capturing device control circuitry 208 determines whether the facial landmarks were determined.

In some examples, if the image capturing device control circuitry 208 determines that facial landmarks were determined (block 404: YES), then the example distance measurement circuitry 204 determines distances between pairs of the determined facial landmarks (block 410). For example, the distance measurement circuitry 204 measures distances by determining a Euclidean distance between two landmark points.

At block 412, the example attentiveness estimation circuitry 206 calculates an attentiveness metric based on the determined distances. For example, the attentiveness estimation circuitry 206 determines whether an audience member, corresponding to a detected face, is paying attention (or, in other words, is attentive) to a media presentation device corresponding to a position of the image capturing device(s) 104. The example attentiveness estimation circuitry 206 uses the determined distances to determine whether the face is turned away from the image capturing device(s) 104, whether the face is looking above the image capturing device(s) 104, whether the face is looking below the image capturing device(s) 104, etc., or whether the face is in a neutral position facing the image capturing device(s) 104.

FIG. 5 is a flowchart representative of example machine readable instructions and/or example operations 500 that may be executed and/or instantiated by processor circuitry to determine distances between each of the determined facial landmarks. The example operations 500 correspond to block 410 of FIG. 4. The machine readable instructions and/or the operations 500 of FIG. 5 begin at block 502, at which the example distance measurement circuitry 204 measures the distance between the facial landmark representative of the left lip and the facial landmark representative of a nose to obtain a first distance. For example, the distance measurement circuitry 204 determines a distance between the left corner of the mouth to a tip of the nose.

At block 504, the example distance measurement circuitry 204 measures the distance between the facial landmark representative of the right lip and the facial landmark representative of the nose to determine a second distance. For example, the distance measurement circuitry 204 determines a distance between the right corner of the mouth to the tip of the nose.

At block 506, the example distance measurement circuitry 204 measures the distance between the facial landmark representative of the right eye and the facial landmark representative of the nose to determine a third distance.

At block 508, the example distance measurement circuitry 204 measures the distance between the facial landmark representative of the left eye and the facial landmark representative of the nose to determine a fourth distance.

At block 510, the example distance measurement circuitry 204 determines a first segment between the facial landmark representative of the left lip and the facial landmark representative of the right lip. For example, the first segment is a line between the corners of the mouth.

At block 512, the example distance measurement circuitry 204 measures the distance between the first segment and the facial landmark representative of the nose to determine a fifth distance.

At block 514, the example distance measurement circuitry 204 determines a second segment between the facial landmark representative of the left eye and the facial landmark representative of the right eye. For example, the second segment is a line between the eyes of the detected face.

At block 516, the example distance measurement circuitry 204 measures the distance between the second segment and the facial landmark representative of the nose to determine a sixth distance.

At block 518, the example distance measurement circuitry 204 normalizes at least one of the first distance, the second distance, the third distance, the fourth distance, the fifth distance, or the sixth distance based on an area of the face. For example, the distance measurement circuitry 204 normalizes facial landmark distances by dividing a facial landmark distance by a square root of the area of the detected face.. In some examples, the distance measurement circuitry 204 divides the first distance by the square root of the area to normalize the first distance, divides the second distance by the square root of the area to normalize the second distance, divides the third distance by the square root of the area to normalize the third distance, divides the fourth distance by the square root of the area to normalize the fourth distance, divides the fifth distance by the square root of the area to normalize the fifth distance, and divides the sixth distance by the square root of the area to normalize the sixth distance.

The example operations 500 end when the example distance measurement circuitry 204 normalizes the first, second, third, fourth, fifth, and sixth distances. The example operations 500 may repeat when facial landmarks are determined for a new frame.

FIG. 6 is a flowchart representative of example machine readable instructions and/or example operations 600 that may be executed and/or instantiated by processor circuitry to determine an attentiveness metric for a given input image. The example operations 600 correspond to block 412 of FIG. 4. The machine readable instructions and/or the operations 600 of FIG. 6 begin at block 602, at which the example attentiveness estimation circuitry 206 (FIG. 2) divides the first distance by the second distance to obtain a first quotient. For example, the attentiveness estimation circuitry 206 divides the distance between the right lip and nose by the distance between the left lip and nose.

At block 604, the example attentiveness estimation circuitry 206 divides the third distance by the fourth distance to obtain a second quotient. For example, the attentiveness estimation circuitry 206 divides the distance between the right eye and the nose by the distance between the left eye and the nose.

At block 606, the example attentiveness estimation circuitry divides the fifth distance by the sixth distance to obtain a third quotient. For example, the attentiveness estimation circuitry 206 divides the distance between the first segment (segment between the corners of the mouth) and the nose by the distance between the second segment (segment between the eyes) and nose.

At block 608, the example attentiveness estimation circuitry 206 compares the first quotient to a first threshold. For example, the attentiveness estimation circuitry 206 determines whether the first distance and the second distance are equal and/or substantially equal. In some examples, the first threshold is indicative of a maximum amount of deviation from a neutral face before the face is identified as not attentive. For example, if the first quotient for a neutral face is equal to “1,” then the first threshold may correspond a value less than and/or greater than “1.”

At block 610, the example attentiveness estimation circuitry 206 determines whether the first quotient satisfies the first threshold. For example, the attentiveness estimation circuitry 206 determines whether the first distance and second distance are substantially equal or whether the first distance and the second distance are not substantially equal.

In some examples, if the attentiveness estimation circuitry 206 determines that the first quotient does not satisfy the first threshold (block 610: NO), the attentiveness estimation circuitry 206 determines that the audience member is not attentive (block 612). For example, if the first distance is greater and/or smaller than the second distance, then the first quotient will not satisfy the threshold. Therefore, it is likely that the audience member is looking left or right of the image capturing device(s) 104 (FIG. 1).

In some examples, if the attentiveness estimation circuitry 206 determines that the first quotient satisfies the first threshold (block 610: YES), the attentiveness estimation circuitry 206 compares the second quotient to a second threshold (block 614). For example, if the distance between the right lip and nose and the distance between the left lip and nose are substantially equal, then the attentiveness estimation circuitry 206 checks whether the distance between the right eye and nose is substantially equal to the distance between the left eye and nose.

At block 616, the example attentiveness estimation circuitry 206 determines whether the second quotient satisfies the second threshold. For example, attentiveness estimation circuitry 206 determines whether the distance between the right eye and nose is substantially equal to the distance between the left eye and nose by comparing the quotient to the second threshold.

In some examples, if the attentiveness estimation circuitry 206 determines that the second quotient does not satisfy the second threshold (block 616: NO), then the attentiveness estimation circuitry 206 determines that the audience member is not attentive (block 612). For example, if the distance between the right eye and nose is greater than the distance between the left eye and nose, then the face of the audience member is looking to the left of the image capturing device(s) 104 (FIG. 1) and, thus, not attentive (e.g., not paying attention to media presented via a media presentation device). In some examples, if the distance between the right eye and nose is less than the distance between the left eye and nose, then the face of the audience member is looking to the right of the image capturing device(s) 104 and, thus, distracted.

In some examples, if the attentiveness estimation circuitry 206 determines that the second quotient satisfies the threshold (block 616: YES), then the attentiveness estimation circuitry 206 compares the third quotient to a third threshold (block 618). For example, if the attentiveness estimation circuitry 206 does not identify side skew of the detected face, then the attentiveness estimation circuitry 206 determines whether there is up or down skew.

At block 620, the example attentiveness estimation circuitry 206 determines whether the third quotient satisfies the third threshold. For example, the attentiveness estimation circuitry 206 determines whether the normalized distance between the center of the eyes to the nose is substantially equal to the normalized distance between the center of the mouth to the nose by comparing the quotient to the third threshold.

In some examples, if the attentiveness estimation circuitry 206 determines that the third quotient does not satisfy the third threshold (block 620: NO), then the attentiveness estimation circuitry 206 determines that the audience member is not attentive (block 612). For example, if the normalized distance between the first segment (the segment between the corners of the mouth) and the nose is greater than the normalized distance between second segment (the segment between the eyes) and the nose, then the face of the audience member is looking up or above the image capturing device(s) 104 and, thus, not attentive (e.g., not paying attention to media presented via a media presentation device). If the normalized distance between the first segment (the segment between the corners of the mouth) and the nose is less than the normalized distance between second segment (the segment between the eyes) and the nose, then the face of the audience member is looking down or below the image capturing device(s) 104 and, thus, not attentive.

In some examples, if the attentiveness estimation circuitry 206 determines that the third quotient satisfies the third threshold (block 620: YES), then the audience member is attentive (block 622). For example, if each of the quotients satisfies the respective thresholds, , then the face of the audience member is looking at or towards the image capturing device(s) 104 and, thus, is attentive (e.g., paying attention to the media presented at via a media presentation device).

The example operations 600 ends when the example attentiveness estimation circuitry 206 determines whether the audience member is attentive or not attentive. In some examples, the operations 600 are repeated when the attentiveness estimation circuitry 206 obtains new distances.

FIG. 7 is a flowchart representative of example machine readable instructions and/or example operations 700 that may be executed and/or instantiated by processor circuitry to track faces in a media presentation environment. The machine readable instructions and/or the operations 700 of FIG. 7 begin at block 702, at which the example face tracking circuitry 210 (FIG. 2) obtains a set of bounding box coordinates for each image frame having a detected object representative of a face. For example, the image capturing device(s) 104 (FIG. 1) may provide one or more frames, at a particular time, including a face. For example, more than one person may be in a media presentation environment at the same time, and the face tracking circuitry 210 may obtain more than one set of bounding box coordinates corresponding to the persons in the media presentation environment.

At block 704, the example face tracking circuitry 210 determines center coordinates for each bounding box. For example, the face tracking circuitry 210 identifies a center of the box bounding a detected face. In some examples, when there is more than one set of bounding box coordinates, the face tracking circuitry 210 determines the center coordinates for each bounding box.

At block 706, the example face tracking circuitry 210 assigns an object identifier to each center coordinate. For example, the face tracking circuitry 210 assigns a unique identifier to each center coordinate because each center coordinate corresponds to a unique object (e.g., different audience members).

At block 708, the example face tracking circuitry 210 stores the center coordinates and the respective object identifier(s) in the example facial attention datastore 212. For example, the face tracking circuitry 210 stores the center coordinates in the facial attention datastore 212 and maps them to their respective unique object identifier.

At block 710, the example face tracking circuitry 210 determines whether new set(s) of bounding box coordinates for new image frame(s) having a detected object(s) representative of a face(s) has/have been obtained. For example, the face tracking circuitry 210 may obtain subsequent image data from the image capturing device(s) 104. In some examples, the image capturing device(s) 104 periodically and/or aperiodically capture image data of the media presentation environment. Therefore, the example face tracking circuitry 210 periodically and/or aperiodically obtains set(s) of bounding box coordinates corresponding to subsequent frames.

If the example face tracking circuitry 210 determines that one or more new set(s) of bounding box coordinates have not been obtained (block 710: NO), the example attentiveness estimation circuitry 206 determines an attentiveness metric for each face assigned with an object identifier (block 724). For example, the attentiveness estimation circuitry 206 executes machine readable instructions 600 to determine whether the face(s) are attentive or not attentive (e.g., distracted).

If the example face tracking circuitry 210 determines that one or more new set(s) of bounding box coordinates have been obtained (block 710: YES), the example face tracking circuitry 210 determines a new center coordinate(s) for the new set(s) of bounding box coordinates (block 712). For example, the face tracking circuitry 210 identifies the center(s) of the box(es) bounding the face(s).

At block 714, the example face tracking circuitry 210 compares the new center coordinate(s) to the previous center coordinate(s) stored in the example facial attention datastore 212. For example, the face tracking circuitry 210 compares a distance between the new center coordinates and each of the previously identified center coordinates.

At block 716, the example face tracking circuitry 210 determines, based on the comparison, whether the new center coordinate(s) is/are associated with any of the previous center coordinate(s). For example, the face tracking circuitry 210 compares a distance between a new center coordinate and a previous center coordinate stored in the facial attention datastore 212 to a distance threshold. In some examples, the distance threshold is indicative of a maximum distance between center coordinates before the center coordinates do not correspond to the same object.

At block 718, the example face tracking circuitry 210 determines whether the distance between coordinates satisfies a distance threshold. For example, the example face tracking circuitry 210 determines, based on the comparison, whether the new center coordinate(s) is/are associated with any of the previous center coordinates.

In some examples, if the face tracking circuitry 210 determines the distance between the coordinates satisfies the distance threshold (block 718: YES), the face tracking circuitry 210 assigns a respective existing object identifier to the new center coordinate (block 720). For example, if the face tracking circuitry 210 determines that a distance between one of the new center coordinates and one of the previous center coordinates satisfies the distance threshold, then the new center coordinate is associated with the previous center coordinate and, thus, should be assigned with the same object identifier as the previous center coordinate.

In some examples, if the face tracking circuitry 210 determines the distance between the coordinates does not satisfy the distance threshold (block 718: NO), the face tracking circuitry 210 assigns a unique object identifier to the new center coordinate (block 722). For example, if the face tracking circuitry 210 compares distances between the new center coordinate and each of the previously stored center coordinates to the distance threshold and none of the distances satisfy the distance threshold, then the new center coordinate is not associated with any previous center coordinates and, thus, should be assigned with a new object identifier.

At block 724, the example attentiveness estimation circuitry 206 determines an attentiveness metric for each face assigned with an object identifier. For example, when a face has been assigned an object identifier, the attentiveness estimation circuitry 206 determines whether that face is distracted or attentive. In some examples, this allows the facial attention determination circuitry 102 to track an object and the attentiveness of that object.

The example operations 700 ends when the example attentiveness estimation circuitry 206 determines the attentiveness metric. In some examples, the operations 700 are repeated when the example face tracking circuitry 210 obtains one or more sets of bounding box coordinates.

FIG. 8 is a block diagram of an example processor platform 800 structured to execute and/or instantiate the machine readable instructions and/or the operations of FIGS. 4-7 to implement the facial attention determination circuitry 102 of FIGS. 1 and 2. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example facial attention determination circuitry 102, the example landmark determination circuitry 202, the example distance measurement circuitry 204, the example attentiveness estimation circuitry 206, the example image capturing device control circuity 208, and the example face tracking circuitry 210.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the mass storage devices 828 implement the example facial attention datastore 212 of FIG. 2.

The machine executable instructions 832, which may be implemented by the machine readable instructions of FIG. 2, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a general purpose microprocessor 900. The general purpose microprocessor circuitry 900 executes some or all of the machine readable instructions of the flowcharts of FIGS. 4-7 to effectively instantiate the circuitry of FIG. 1 as logic circuits to perform the operations corresponding to those machine readable instructions. In some such examples, the circuitry of FIG. 1 is instantiated by the hardware circuits of the microprocessor 900 in combination with the instructions. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 4-7.

The cores 902 may communicate by a first example bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may implement at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 4-7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 4-7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 4-7. As such, the FPGA circuitry 1000 may be structured to effectively instantiate some or all of the machine readable instructions of the flowcharts of FIGS. 4-7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 4-7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIGS. 4-7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 4-7 may be executed by one or more of the cores 902 of FIG. 9, a second portion of the machine readable instructions represented by the flowcharts of FIGS. 4-7 may be executed by the FPGA circuitry 1000 of FIG. 10, and/or a third portion of the machine readable instructions represented by the flowcharts of FIGS. 4-7 may be executed by an ASIC. It should be understood that some or all of the circuitry of FIGS. 1 and 2 may, thus, be instantiated at the same or different times. Some or all of the circuitry may be instantiated, for example, in one or more threads executing concurrently and/or in series. Moreover, in some examples, some or all of the circuitry of FIGS. 1 and 2 may be implemented within one or more virtual machines and/or containers executing on the microprocessor.

In some examples, the processor circuitry 812 of FIG. 8 may be in one or more packages. For example, the processor circuitry 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

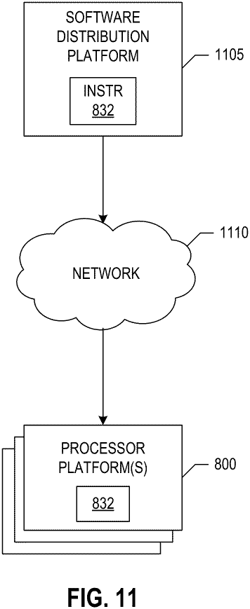

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 400, 500, 600, and 700 of FIGS. 4-7, as described above. The one or more servers of the example software distribution platform 1105 are in communication with a network 1110, which may correspond to any one or more of the Internet and/or any of the example network 826 of FIG. 8 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 400, 500, 600, and 700 of FIGS. 4-7, may be downloaded to the example processor platform 800, which is to execute the machine readable instructions 832 to implement the example facial attention determination circuitry 102 of FIG. 1. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to comprising:
at least one memory;
machine readable instructions; and
processor circuitry to at least one of instantiate or execute the machine readable instructions to:
identify facial landmarks from input image data, the facial landmarks corresponding to coordinates of landmarks of a face detected in the input image data;
determine a first distance between a first facial landmark of the facial landmarks and a second facial landmark of the facial landmarks;
determine a second distance between the first facial landmark and a third facial landmark of the facial landmarks; and
compare a quotient of the first distance and the second distance to a threshold to determine an attentiveness metric.

2. The apparatus of claim 1, wherein the processor circuitry is to:
determine that no facial landmarks were identified;
in response to no facial landmarks being identified, instruct an image capturing device to adjust a configuration of the image capturing device; and
obtain adjusted input image data from the image capturing device.

3. The apparatus of claim 1, wherein the quotient is a first quotient, the threshold is a first threshold, and the processor circuitry is to:
determine the first quotient satisfies the first threshold; and
compare a second quotient of a third distance and a fourth distance to a second threshold to determine the attentiveness metric, the third distance between the first facial landmark and a fourth facial landmark of the facial landmarks, the fourth distance between the first facial landmark and a fifth facial landmark of the facial landmarks.

4. The apparatus of claim 3, wherein the processor circuitry is to, in response to the second quotient not satisfying the threshold, identify that the face is distracted.

5. The apparatus of claim 1, wherein the processor circuitry is to:
determine an area of the face;
determine a first normalized distance based on a square root of the area of the face and the first distance; and
determine a second normalized distance based on the square root of the area of the face and the second distance.

6. The apparatus of claim 1, wherein the processor circuitry is to track the attentiveness metric of the face over a period of time using centroid tracking.

7. The apparatus of claim 1, wherein the input image data includes a first image and a second image, the face is a first face detected in the first image, the attentiveness metric is a first attentiveness metric associated with the first face in the first image, the threshold is a first threshold, and the processor circuitry is to:
obtain a first set of bounding box coordinates bounding the first face in the first image and a second set of bounding box coordinates bounding a second face detected in the second image;
determine a first center coordinate of the first set of bounding box coordinates;
assign an object identifier to the first center coordinate;
determine a second center coordinate of the second set of bounding box coordinates;
compare a third distance between the first center coordinate and the second center coordinate to a second threshold to determine whether the second center coordinate is associated with the first center coordinate;
in response to the third distance satisfying the second threshold, assign the object identifier to the second center coordinate to identify the second face as corresponding to the first face; and
determine a second attentiveness metric associated with the second face in the second image.

8. The apparatus of claim 7, wherein the processor circuitry is to:
in response to the third distance not satisfying the second threshold, assign a unique object identifier to the second center coordinate, the unique object identifier identify the second face is different from the first face; and
determine a third attentiveness metric associated with the second face in the second image.

9. The apparatus of claim 1, wherein the threshold is indicative of a maximum amount of deviation from a neutral face before the face is identified as distracted.

10. A non-transitory machine readable storage medium comprising instructions that, when executed, cause processor circuitry to at least:
identify facial landmarks from input image data, the facial landmarks corresponding to coordinates of landmarks of a face detected in the input image data;
determine a first distance between a first facial landmark of the facial landmarks and a second facial landmark of the facial landmarks;
determine a second distance between the first facial landmark and a third facial landmark of the facial landmarks; and
compare a quotient of the first distance and the second distance to a threshold to determine an attentiveness metric.

11. The non-transitory computer-readable medium of claim 10, wherein the instructions, when executed, cause the machine to:
determine that no facial landmarks were identified;
in response to no facial landmarks being identified, instruct an image capturing device to adjust a configuration of the image capturing device; and
obtain adjusted input image data from the image capturing device.

12. The non-transitory computer-readable medium of claim 10, wherein the quotient is a first quotient, the threshold is a first threshold and the instructions, when executed, cause the machine to:
determine the first quotient satisfies the first threshold; and
compare a second quotient of a third distance and a fourth distance to a second threshold to determine the attentiveness metric, the third distance between the first facial landmark and a fourth facial landmark of the facial landmarks, the fourth distance between the first facial landmark and a fifth facial landmark of the facial landmarks.

13. The non-transitory computer-readable medium of claim 12, wherein the instructions, when executed, cause the machine to, in response to the second quotient not satisfying the threshold, identify that the face is distracted.

14. The non-transitory computer-readable medium of claim 10, wherein the instructions, when executed, cause the machine to:
determine an area of the face;
determine a first normalized distance based on a square root of the area of the face and the first distance; and
determine a second normalized distance based on the square root of the area of the face and the second distance.

15. The non-transitory computer-readable medium of claim 10, wherein the instructions, when executed, cause the machine to track the attentiveness metric of the face over a period of time using centroid tracking.

16. The non-transitory computer-readable medium of claim 10, wherein the input image data includes a first image and a second image, the face is a first face detected in the first image, the attentiveness metric is a first attentiveness metric associated with the first face in the first image, the threshold is a first threshold, and the instructions, when executed, cause the machine to:
obtain a first set of bounding box coordinates bounding the first face in the first image and a second set of bounding box coordinates bounding a second face detected in the second image;
determine a first center coordinate of the first set of bounding box coordinates;
assign an object identifier to the first center coordinate;
determine a second center coordinate of the second set of bounding box coordinates;
compare a third distance between the first center coordinate and the second center coordinate to a second threshold to determine whether the second center coordinate is associated with the first center coordinate;
in response to the third distance satisfying the second threshold, assign the object identifier to the second center coordinate to identify the second face as corresponding to the first face; and
determine a second attentiveness metric associated with the second face in the second image.

17. The non-transitory computer-readable medium of claim 16, wherein the instructions, when executed, cause the machine to:
in response to the third distance not satisfying the second threshold, assign a unique object identifier to the second center coordinate, the unique object identifier identify the second face is different from the first face; and
determine a third attentiveness metric associated with the second face in the second image.

18. The non-transitory computer-readable medium of claim 10, wherein the threshold is indicative of a maximum amount of deviation from a neutral face before the face is identified as distracted.

19. A method comprising:
identifying, by executing an instruction with programmable circuitry, facial landmarks from input image data, the facial landmarks corresponding to coordinates of landmarks of a face detected in the input image data;
determining, by executing an instruction with the programmable circuitry, a first distance between a first facial landmark of the facial landmarks and a second facial landmark of the facial landmarks;
determining, by executing an instruction with the programmable circuitry, a second distance between the first facial landmark and a third facial landmark of the facial landmarks; and
comparing, by executing an instruction with the programmable circuitry, a quotient of the first distance and the second distance to a threshold to determine an attentiveness metric.

20. The method of claim 19, further including:
determining that no facial landmarks were identified;
in response to no facial landmarks being identified, instructing an image capturing device to adjust a configuration of the image capturing device; and
obtaining adjusted input image data from the image capturing device.

21-27. (canceled)
